(19) United States
(12) Patent Application Publication
(10) Pub. No.: US 2010/0260368 A1
(43) Pub. Date: Oct. 14, 2010

(54) HEARING DEVICE WITH BATTERY FLAP MODULE

(75) Inventors: Markus Heerlein, Singapore (SG); Harald Klemenz, Furth (DE); Daniel Reisse, Erlangen (DE)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/747,959

(22) PCT Filed: Sep. 8, 2008
(86) PCT No.: PCT/EP08/61864

§ 371 Date: Jun. 14, 2010

(30) Foreign Application Priority Data
Dec. 12, 2007 (DE) 10 2007 059 723.3

(51) Int. Cl. H04R 25/00

(52) U.S. Cl. 381/323

(57) ABSTRACT

Shells of hearing devices, and in particular for hearing aids, are frequently manufactured using an RSM method and battery flaps are injection-molded. Problems arise frequently due to the varying error tolerances of the two processes when the battery compartment is locked into position on the shell. For this reason a hearing device with a shell, which has a battery opening and a battery flap, which is injection-molded from plastic, is provided for closing the battery opening. The hearing device also has a module which is likewise injection-molded from plastic, on which the battery flap is pivotally supported and which has a detent mechanism via which the battery flap locks into place detachably in a closed position to prevent a pivot movement. Since the injection-molded battery flap locks into position with the injection-molded module, the error tolerances of the shell, often produced by an RSM method, play no part.

The present invention relates to a hearing device with a shell that has a battery opening and a battery flap that is injection-molded from plastic for closing the battery opening. The term “hearing device” in this case is understood to mean any portable sound-emitting equipment in/on the ear, in particular a hearing aid, a headset, earphones or the like.

Hearing aids are portable hearing devices used to support the hard of hearing. In order to make concessions for the numerous individual requirements, different types of hearing aids are provided, e.g. behind-the-ear (BTE) hearing aids, a hearing aid with an external headset (receiver in the canal [RIC]) and in-the-ear (ITE) hearing aids, for example concha hearing aids or canal hearing aids (ITE, CIC) as well. The hearing aids listed in an exemplary fashion are worn on the concha or in the auditory canal. Furthermore, bone conduction hearing aids, implantable or vibrotactile hearing aids are also commercially available. In this case, the damaged sense of hearing is stimulated either mechanically or electrically.

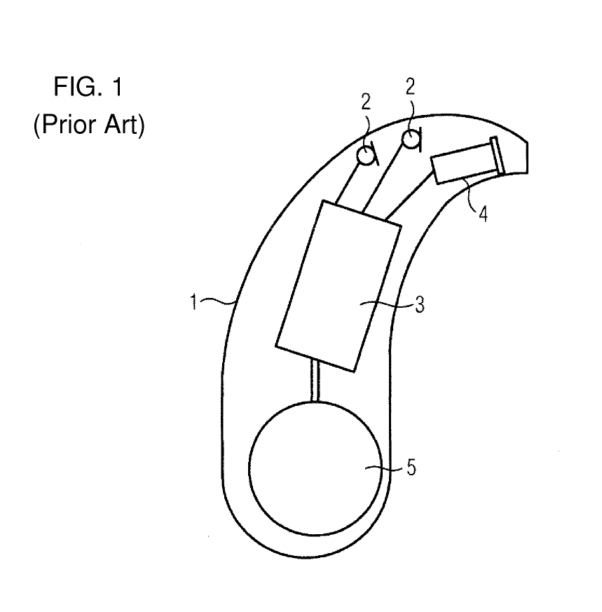

In principle, the main components of hearing aids are an input transducer, an amplifier and an output transducer. In general, the input transducer is a sound receiver, e.g. a microphone, and/or an electromagnetic receiver, e.g. an induction coil. The output transducer is usually designed as an electroacoustic transducer, e.g. a miniaturized loudspeaker, or as an electromechanical transducer, e.g. a bone conduction headset. The amplifier is usually integrated into a signal-processing unit. This basic design is illustrated in FIG. 1 using the example of a behind-the-ear hearing aid. One or more microphones 2 for recording the sound from the surroundings are installed in a hearing aid housing 1 to be worn behind the ear.

A signal-processing unit 3, likewise integrated into the hearing aid housing 1, processes the microphone signals and amplifies them. The output signal of the signal-processing unit 3 is transferred to a loudspeaker or headset 4, which emits an acoustic signal. If necessary, the sound is transferred to the eardrum of the equipment wearer using a sound tube, which is fixed in the auditory canal with an ear mold. A battery 5 likewise integrated into the hearing aid housing 1 supplies the hearing aid and in particular the signal-processing unit 3 with energy.

Hearing aids in general consist of a plurality of components made of plastic. Different production methods are occasionally used for producing these components and parts. However, the disadvantage of components produced by various methods is that they have different production tolerances and thus it is always the largest tolerances that are decisive when assembling the components.

In general, the battery case or battery flap of an ITE hearing aid is produced as an injection-molded part. The battery case latches into a so-called faceplate that, together with the hearing aid shell, is formed in an RSM (rapid shell manufacturing) method, more particularly in an SLA (stereo lithography apparatus) method, as an integrated faceplate, that is to say as an RSM part or SLA part. However, the tolerances of these two production methods (injection molding and SLA) differ by a factor of 10. This makes defined latching of the battery case difficult or almost impossible.

In particular, an RSM (SLA) method used for producing the ITE shells or integrated faceplates has an error tolerance of 0.1 to 0.3 mm. By contrast, battery flaps are generally produced as injection-molded parts with an error tolerance of approximately 0.02 mm. Thus, this difference in tolerances often results in the battery flap not fitting precisely to the locking system of the RSM shell. As a result, the battery flap opens and closes very easily in some units, whilst this is only possible with great difficulty in other units. However, this problem always occurs in principle if RSM (SLA) parts and injection-molded parts meet in the hearing devices.

Document EP 0 681 412 A2 discloses a control unit for a canal hearing aid (CIC), which unit additionally holds, in part, a battery of the hearing aid. Moreover, the control unit additionally acts as a cover. A reduction in the overall size is intended to be obtained thereby. The cover element of the control unit can be pivoted about an axis and it clips into a recess in the hearing aid housing when closed.

Therefore, the object of the present invention consists of proposing a hearing device in which the different error tolerances of the different production methods have less of an adverse influence on the functionality of the battery flap.

According to the invention, this object is achieved by a hearing device with a shell that has a battery opening and a battery flap that is injection-molded from plastic for closing the battery opening, and also a module, which is likewise injection-molded from plastic, on which the battery flap is mounted such that it can pivot and which has a detent mechanism by means of which the battery flap detachably latches in a closed position in order to prevent a pivoting movement.

Advantageously, both the battery flap and the module, on which the battery flap is mounted such that it can pivot and into which the former latches, are implemented as an injection-molded part with low error tolerance. As a result, the functionality of the battery flap including the pivoting and the latching in a closed position and/or opened position is almost independent of the production method of the shell or of the integrated faceplate. It follows that the necessary force for opening and closing the battery flap can be set in a more defined fashion, which has a positive influence on the handling of the hearing device.

By way of example, the battery flap can be designed as a battery case. This means that the battery is held mechanically in the battery flap, which increases the necessity of the detent mechanisms satisfying the prescribed functions and so loose connections, for example, can be avoided.

The shell of the hearing device preferably has a guide parallel to the battery opening, onto/into which the module, having a fitting guide element according to the tongue-and-groove principle, is pushed. For this tongue-groove guide, different error tolerances between shell and module are less important because the module does not have to be removed by the user, whereas the battery flap is actuated by the user of the hearing device.

According to a further preferred embodiment, the detent mechanism is arranged radially closer to the pivot axis of the battery flap than to the free end of the battery flap with respect to the pivot axis. The advantage of this is that the module can have a relatively small design and sufficient space remains for the battery during the pivoting movement or the insertion/removal.

Furthermore, the detent mechanism can have a notch in the module and a detent lug on the battery flap. Conversely, in principle, it is also possible for a notch to be provided in the battery flap and a detent lug to be provided on the module.

The battery flap can also have a lobe, into which a bearing pin engages to form the pivot bearing. This lobe can be combined with the detent mechanism as a result of the lobe having an end section that latches into a first recess in the closed position of the battery flap and latches into a second recess in an opened position of the battery flap. Alternatively, the lobe can also have a connecting member with two separate recesses, and so a projection on the module latches into a first of the recesses in the closed position and into a second of the recesses in an opened position. This dual function of the pivot bearing, in which the detent mechanism is directly arranged on the pivot axis, allows an even smaller design of the module.

The present invention will be explained in more detail on the basis of the attached drawings, in which:

FIG. 1 shows the basic design of a hearing aid as per the prior art;

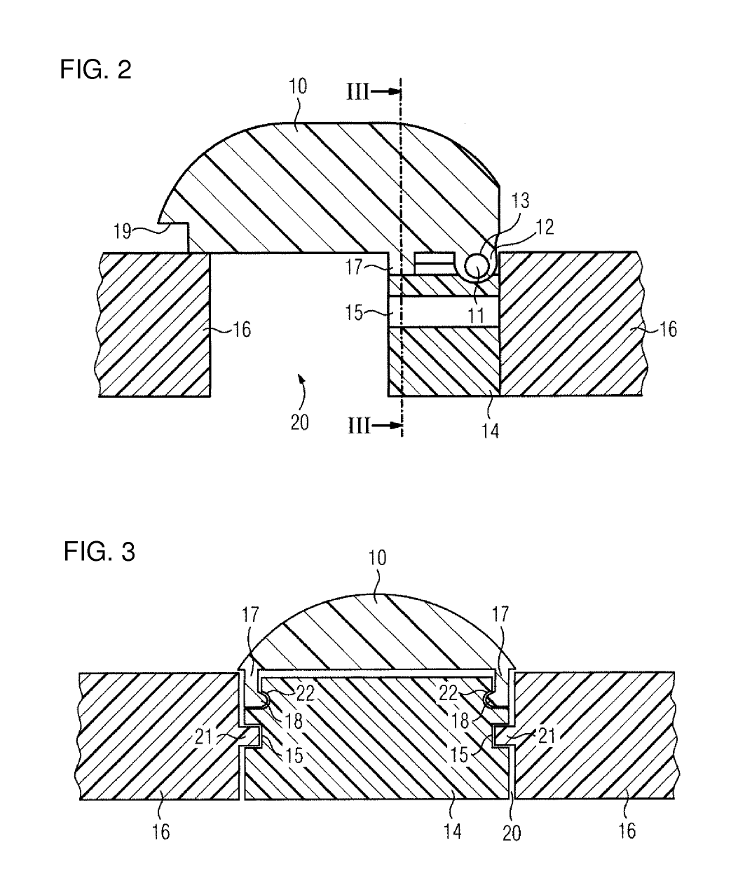

FIG. 2 shows a section through a hearing device as per a first embodiment, which section is transverse to the pivot axis of the battery flap;

FIG. 3 shows a section through the hearing device from FIG. 2, which section is parallel to the pivot axis and

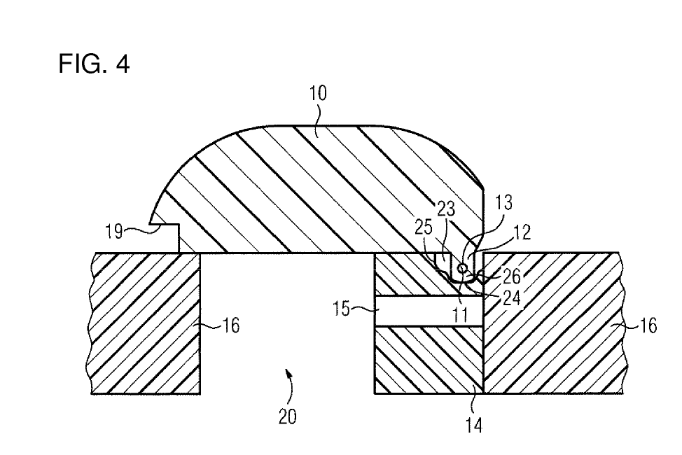

FIG. 4 shows a section through a hearing device as per a second embodiment of the present invention, which section is transverse to the pivot axis.

The embodiments described in more detail below constitute preferred exemplary embodiments of the present invention.

A first exemplary embodiment of a hearing aid according to the invention is illustrated in part in FIG. 2. More precisely, FIG. 2 illustrates a section through a battery flap 10, mounted such that it can pivot, transversely relative to the pivot-bearing pin 11. The battery flap 10 has a lobe 12 with a circular hole 13, within which the pivot-bearing pin 11 is held to form the pivot bearing. The pivot-bearing pin 11 is part of a module 14 or securely fastened therein. The module 14 has a groove 15 by means of which said module is attached to an RSM shell 16. FIG. 2 only illustrates part of the RSM shell, which forms the hearing aid shell, on respectively the left-hand and right-hand side of the battery flap 10.

Furthermore, the battery flap 10 has a projection 17 that extends along the lower side of the battery flap 10 in the tangential direction relative to the pivot bearing 11, 13. This projection 17 has a lug 18 on its rear side facing away from the observer in FIG. 2 (cf. FIG. 3). Said lug is, together with the projection 17, part of a locking mechanism, by means of which the battery flap 10 is locked or latched in the closed position illustrated in FIG. 2. In this closed position, the battery flap 10 then covers the battery opening 20 situated in the RSM shell 16. In order to open the battery flap 10, it has an undercut 19 at the free end lying opposite the pivot bearing 11, 13. The hearing aid wearer can then for example place his/her finger nail into the undercut 19 in order to open the battery flap 10.

FIG. 3 illustrates the section of the battery flap 10 from FIG. 2 along the section III-III, that is to say parallel to the pivot bearing 11, 13. The module 14 is situated in the battery opening 20. It has respectively one groove 15 on both sides, into which in each case one spring 21 of the hearing aid shell or RSM shell 16 protrudes. The module 14, including the battery flap 10 mounted thereon such that it can pivot, is pushed onto the springs 21 during the assembly. Since these have relatively large tolerances compared to injection molding as a result of the RSM production method, they should be dimensioned such that there is always a fixed connection by friction between RSM shell 16 and module 14, despite the tolerances. Here, the tolerances of the grooves 15 of the injection-molded module 14 hardly play a part. Depending on how large the springs 21 turn out during producing, greater or smaller forces have to be applied for pushing the module 14 onto the springs 21. These different forces are not a hindrance during assembly, whereas different forces when the hearing aid wearer handles the battery flap would be annoying.

In order to latch the battery flap 10 in the closed position, the flap 10 has the aforementioned projections 17, each with lugs 18. The lugs 18 latch into cutouts 22 of the module 14 when the battery flap is closed. Since both the module 14 and the battery flap 10 including the projections 17 and the lugs 18 are produced using the injection-molding method, these components all have the same low error tolerance of approximately 0.02 mm. Therefore, the battery flap 10 can always latch on the module 14 with practically the same force.

A second exemplary embodiment of the hearing device according to the invention with a battery flap module, produced by an injection-molding method, is reproduced in FIG. 4. The illustration again corresponds to a section perpendicular to the pivot bearing 11, 13. Most components of this embodiment correspond to those of the embodiment in FIG. 2. They have been provided with the same reference signs, and reference is made to the description from FIG. 2 in respect of their function. However, in the exemplary embodiment of FIG. 4, the locking mechanism consists of a connecting member 23, which is formed into the module 14 as a cutout. It has a first recess 24 and a second recess 25 separated therefrom by a slight elevation. A projecting section 26 of the lobe 12 is also part of the locking mechanism. This projecting section 26 latches into the first recess 24 when the battery flap 10 is in the closed position as in FIG. 4. If the battery flap 10 is pivoted into an opened position, the projecting section 26 of the lobe 12 is pushed into the second recess 25 of the connecting member 23 and latches therein. Thus, the battery flap 10 remains in a defined opened position. Since the detent mechanism or locking mechanism is very close to the pivot bearing 11, 13, the module 14 can be of a very small design.

The two exemplary embodiments above illustrate the principle according to the invention, according to which the closure mechanism has been moved from the front part of the battery flap 10 to the rear part. In the process, the locking mechanism can be situated in the framing of the injection-molded module. Hence, the locking mechanism can be produced with the same method as the remainder of the module 14. It follows that the injection-molded parts can be matched to one another in a better and more precise fashion, because the error tolerances are the same in the involved components. More precisely, this means that the closure mechanism of the battery case is completely detached from the shell. Hence, the battery flap can be opened and closed without problems. However, there are advantages not only for the end user, but also during the production, because two different production methods with two different error tolerances do not have to be matched to one another. In end effect, there is an increase in the quality of the hearing device or of the hearing aid.

1-8. (canceled)

9. A hearing device, comprising:
a shell formed with a battery opening;
an injection-molded plastic battery flap disposed for closing said battery opening;
an injection-molded plastic module pivotally supporting said battery flap thereon; and
a detent mechanism configured to detachably latch said battery flap in a closed position in order to prevent a pivoting movement.

10. The hearing device according to claim 9, wherein said battery flap is a battery case.

11. The hearing device according to claim 9, wherein said shell is formed with a guide extending parallel to said battery opening, said module is formed with a corresponding fitting guide element, enabling said module to be fitted on said guide in a tongue-and-groove relationship.

12. The hearing device according to claim 9, wherein said detent mechanism is disposed radially closer to a pivot axis of said battery flap than to a free end of said battery flap with respect to the pivot axis.

13. The hearing device according to claim 9, wherein said detent mechanism includes a notch formed in said module and a detent lug on said battery flap.

14. The hearing device according to claim 9, wherein said battery flap is formed with a lobe, and wherein a bearing pin is disposed to engage in said lobe to form a pivot bearing.

15. The hearing device according to claim 14, wherein said lobe has an end section latching into a first recess in the closed position of said battery flap and latching into a second recess in an opened position of said battery flap.

16. The hearing device according to claim 14, wherein said lobe includes a connecting member formed with a first recess and a separate, second recess, and wherein said module includes a projection latching into said first recess in the closed position and latching into said second recess in an opened position.
